(19) United States
(12) Patent Application Publication
(10) Pub. No.: US 2017/0134996 A1
(43) Pub. Date: May 11, 2017

(54) COMMUNICATION SYSTEM ADAPTED FOR KEY DERIVATION DURING HANDOVER

(71) Applicant: NEC Corporation, Minato-ku, Tokyo (JP)

(72) Inventors: Meng WANG, Guildford (GB); Yoshio UEDA, Tokyo (JP); Atsushi NAKATA, Tokyo (JP)

(73) Assignee: NEC Corporation, Minato-ku, Tokyo (JP)

(21) Appl. No.: 15/318,827

(22) PCT Filed: Jun. 22, 2015
(86) PCT No.: PCT/JP2015/068595

§ 371 Date: Dec. 14, 2016

(30) Foreign Application Priority Data
Jun. 23, 2014 (GB) 1411149.6

(51) Int. Cl. H04W 36/00; H04L 29/06; H04W 12/04; H04W 36/38

(52) U.S. Cl. CPC H04W 36/0038; H04W 36/0072; H04W 36/38; H04L 63/0428; H04W 12/04; H04W 88/16

(57) ABSTRACT

A communication system is disclosed comprising a gateway connecting a source base station and a target base station. The gateway receives a message from the source base station initiating a handover of a mobile device from the source to the target base station. The received message comprises a security context (an NCC-K_{eNB} pair and/or a K_{eNB}*) for securing communications with the mobile device, and for deriving a further key for securing subsequent communications with the mobile device. The gateway generates and sends, to the target base station, a message requesting the target base station to carry out a handover, the message comprising the security context.

### TECHNICAL FIELD

The present invention relates to a communication system and to components thereof for providing communication services to mobile or fixed communication devices. The invention has particular but not exclusive relevance to the implementation of a so-called home base station (HeNB) gateway (a gateway that connects ‘small’ cells or Low Power Nodes (LPNs) to a core network) in Long Term Evolution (LTE) communication systems currently being developed by the 3^{rd} Generation Partnership Project (3GPP).

### BACKGROUND ART

In 3GPP LTE networks, a base station (i.e. evolved NodeB, eNB) of a Radio Access Network (RAN) transmits data and signalling between a core network (CN) and User Equipment (UEs) located within the base station's coverage area. In LTE, the RAN is referred to as the Evolved Universal Terrestrial Radio Access (E-UTRA) network (E-UTRAN) and the core network is referred to as the Evolved Packet Core (EPC) network. User equipment may comprise, for example, mobile telephones, mobile communication devices, user communication devices, laptop computers, and/or the like.

Recent developments in communication networks have seen increased deployment of so called ‘small’ cells operated by Low Power Nodes (LPNs), such as pico eNBs, femto eNBs, Home eNBs (HeNBs) or the like, which cells have a smaller coverage area than existing macro cells operated by a higher power macro base station. Networks comprising a number of different cell types, for example a network comprising a macro cell and a femto cell, are referred to as Heterogeneous Networks, or HetNets.

The LPNs/small cell base stations that operate small cells can typically communicate with the core network and with macro base stations via a small cell gateway. Some small cell gateways have a so-called home evolved nodeB gateway (HeNB GW) functionality to provide connectivity from the LPN/small cell base station to the core network, although such connectivity from the LPN/small cell base station to the core network may also be provided directly, e.g. without requiring any HeNB GW functionality.

More recently the need to make further enhancements to small cells using low-power nodes has been identified as one of the most important topics for further development of 3GPP standards compliant communication systems in order to enable such communication systems to cope with increases in mobile traffic especially for hotspot deployments in indoor and outdoor scenarios. According to this interest in small cell enhancements, scenarios and requirements for small cell enhancements were studied and captured in a 3GPP technical report (3GPP TR 36.932), the contents of which are herein incorporated by reference.

In such deployment scenarios, possibly involving a large number of base stations (of various types), the volume of signalling in the communication system may be significant. In order to address this issue, some of the core network functionalities, e.g. handover related functionalities may be provided by a HeNB GW instead of a core network entity (e.g. a mobility management entity, MME). Typically, the handover related functionalities may be provided by a HeNB GW when both the old (source) and the new (target) base station are connected to the same HeNB GW. This approach reduces the amount of signalling that needs to be exchanged between the core network and the access network (HeNB GW and/or base stations) during handover and thus improves the overall system efficiency.

Whenever an item of user equipment (e.g. a mobile telephone) is handed over between base stations, (the corresponding endpoint of) the associated ‘S1’ connection (i.e. the communications link between the user equipment's serving base station and the core network) is handed over as well, from the source base station to the target base station. Such an S1 handover involves the provision of a new cryptographic key for the target base station, which is assisted by the MME sending input information (known as security context) to the target base station, based on which the target base station can derive its own cryptographic key (referred to as the K_{eNB}*, whilst the K_{eNB} denotes the cryptographic key used by the old, i.e. the source base station).

Specifically, the security context sent by the MMF includes the current cryptographic key(s) and chaining information for the next hop (i.e. the target base station) access key derivation. The cryptographic key (of the source base station) comprises the K_{eNB} and the chaining information comprises the Next Hop Parameter (NH) and the NH Chaining Counter (NCC). Using the received cryptographic keys and chaining information, together with its own Physical Cell Identity (PCI) and E-UTRA Absolute Radio Frequency Channel Number (EARFCN), the target base station is able to derive the K_{eNB}* to be used in subsequent communications with the mobile communication device that has been handed over.

However, there is a problem when the handover is performed without involving the MME, because the required security context cannot be provided from the MME to the target base station, simply because the HeNB GW does not communicate with the MME during a handover between two base stations connected to that HeNB GW. This might result in the user equipment and the target base station being unable to communicate with each other (and/or with the core network) until a new, valid security key is derived by the target base station. However, as described above, this usually requires additional signalling between the target base station and the MME, in the absence of which it may not be possible to support secure (encrypted) communications for the user equipment via the target base station (at least until the appropriate K_{eNB}* is derived by the target base station).

### DISCLOSURE OF THE INVENTION

### Problem(s) to be Solved by the Invention

Accordingly, preferred embodiments of the present invention aim to provide methods and apparatus which overcome or at least alleviate the above issues without necessitating additional signalling towards the core network.

### Means to Solve the Problem

In one aspect, the invention provides a base station for a communication system, the communication system comprising at least one mobile communication device, a plurality of base stations, a gateway apparatus operable to facilitate communication of messages between the plurality of base stations, and a mobility management entity via which the gateway apparatus can be connected to a core network, the base station comprising: means for generating a message for initiating a handover of the mobile communication device from the base station to another base station, the message comprising a security context associated with the mobile communication device, the security context including: a key for securing communications with the mobile communication device; and a current value of an associated counter for deriving a further key for securing subsequent communications with the mobile communication device. The base station comprises means for sending the generated message to the gateway apparatus, the message including the security context.

In one aspect, the invention provides a base station for a communication system, the communication system comprising at least one mobile communication device, a plurality of base stations, a gateway apparatus operable to facilitate communication of messages between the plurality of base stations, and a mobility management entity via which the gateway apparatus can be connected to a core network, the base station comprising: means for generating a message for initiating a handover of the mobile communication device from the base station to another base station, the message comprising information for identifying a cell and information for identifying a frequency channel of the other base station, wherein the information is included in one or more non-radio resource control, non-RRC, encoded information elements configured to convey cell information between the base station and other nodes of the communication system; and means for sending the generated message to the gateway apparatus, the message including the one or more non-RRC encoded information elements.

In one aspect, the invention provides a base station for a communication system, the communication system comprising at least one mobile communication device, a plurality of base stations, a gateway apparatus operable to facilitate communication of messages between the plurality of base stations, and a mobility management entity via which the gateway apparatus can be connected to a core network, the base station comprising: means for receiving a message from the gateway apparatus, the message requesting the base station to carry out a handover of the mobile communication device from another base station, the message comprising a security context associated with the mobile communication device, the security context including: a key for securing communications with the mobile communication device; and a current value of an associated counter for deriving a further key for securing subsequent communications with the mobile communication device. The base station comprises means for performing the requested handover of the mobile communication device; and means for securing communications with the mobile communication device using the received key.

In one aspect, the invention provides a gateway apparatus comprising: means for receiving a message, from a first base station, for initiating a handover of a mobile communication device from the first base station to a second base station, the received message comprising: (a) data to be forwarded to the second base station, the data relating to the handover of the mobile communication device from the first base station to the second base station; (b) a security context associated with the mobile communication device, the security context including: a key for securing communications with the mobile communication device; and a current value of an associated counter for deriving a further key for securing subsequent communications with the mobile communication device. The gateway apparatus comprises means for generating a message requesting the second base station to carry out a handover of the mobile communication device from the first base station, the generated message comprising information for deriving a further key for securing communications with the mobile communication device, wherein the information for deriving a further key is included in a security context portion forming part of the generated message; and means for sending the generated message to the second base station.

In one aspect, the invention provides a gateway apparatus comprising: means for obtaining, from a core network node, a security context associated with a mobile communication device, the security context including: a key for securing communications with the mobile communication device; and a current value of an associated counter for deriving a further key for securing subsequent communications with the mobile communication device; means for receiving a message, from a first base station of plurality of base stations, for initiating a handover of the mobile communication device from the first base station to a second base station, the received message comprising data to be forwarded to the second base station, the data relating to the handover of the mobile communication device from the first base station to the second base station; means for generating information for deriving a further key for securing communications with the mobile communication device; means for generating a message requesting the second base station to carry out a handover of the mobile communication device from the first base station, the generated message comprising the information for deriving a further key for securing communications with the mobile communication device, wherein the information is included in a security context portion forming part of the generated message; and means for sending the generated message to the second base station.

In one aspect, the invention provides a communication system comprising one or more of the above described base station; and the above described gateway apparatus.

In one aspect, the invention provides a method performed by a base station in a communication system, the communication system comprising at least one mobile communication device, a plurality of base stations, a gateway apparatus operable to facilitate communication of messages between the plurality of base stations, and an mobility management entity via which the gateway apparatus can be connected to a core network, the method comprising: generating a message initiating a handover of the mobile communication device from the base station to another base station, the message comprising a security context associated with the mobile communication device, the security context including: a current key for securing communications with the mobile communication device; and a current value of an associated counter for deriving a further key for securing subsequent communications with the mobile communication device; and sending the generated message to the gateway apparatus, the message including the security context.

In one aspect, the invention provides a method performed by a base station in a communication system, the communication system comprising at least one mobile communication device, a plurality of base stations, a gateway apparatus operable to facilitate communication of messages between the plurality of base stations, and an mobility management entity via which the gateway apparatus can be connected to a core network, the method comprising: generating a message for initiating a handover of the mobile communication device from the base station to another base station, the message comprising information for identifying a cell and information for identifying a channel of the other base station, wherein the information is included in one or more non-radio resource control, non-RRC, encoded information element configured to convey cell information between the base station and other nodes of the communication system; and sending the generated message to the gateway apparatus, the message including the one or more information elements.

In one aspect, the invention provides a method performed by a base station in a communication system, the communication system comprising at least one mobile communication device, a plurality of base stations, a gateway apparatus operable to facilitate communication of messages between the plurality of base stations, and a mobility management entity via which the gateway apparatus can be connected to a core network, the method comprising: receiving a message from the gateway apparatus, the message requesting the base station to carry out a handover of the mobile communication device from another base station, the message comprising a security context associated with the mobile communication device, the security context including: a key for securing communications with the mobile communication device; and a current value of an associated counter for deriving a further key for securing subsequent communications with the mobile communication device; performing the requested handover of the mobile communication device; and securing communications with the mobile communication device using the received key.

In one aspect, the invention provides a method performed by a gateway apparatus, the method comprising: receiving a message from a first base station, the message initiating a handover of a mobile communication device from the first base station to a second base station, the received message comprising: (a) data to be forwarded to the second base station, the data relating to the handover of the mobile communication device from the first base station to the second base station; (b) a security context associated with the mobile communication device, the security context including: a key for securing communications with the mobile communication device; and a current value of an associated counter for deriving a further key for securing subsequent communications with the mobile communication device; generating a message requesting the second base station to carry out a handover of the mobile communication device from the first base station, the generated message comprising information for deriving a further key for securing communications with the mobile communication device, wherein the information for deriving a further key is included in a security context portion forming part of the generated message; and sending the generated message to the second base station.

In one aspect, the invention provides a method performed by a gateway apparatus, the method comprising: obtaining, from a core network node, a security context associated with a mobile communication device, the security context including: a key for securing communications with the mobile communication device; and a current value of an associated counter for deriving a further key for securing subsequent communications with the mobile communication device; receiving a message from a first base station, the message initiating a handover of the mobile communication device from the first base station to a second base station, the received message comprising data to be forwarded to the second base station, the data relating to the handover of the mobile communication device from the first base station to the second base station; generating information for deriving a further key for securing communications with the mobile communication device; generating a message requesting the second base station to carry out a handover of the mobile communication device from the first base station, the generated message comprising the information for deriving a further key for securing communications with the mobile communication device, wherein the information is included in a security context portion forming part of the generated message; and sending the generated message to the second base station.

Aspects of the invention extend to computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the invention will be described in detail in the context of a 3G system (UMTS, LTE), the principles of the invention can be applied to other systems (such as WiMAX) in which (home/small cell) base stations communicate via a signalling gateway with the corresponding elements of the system changed as required.

### BRIEF DESCRIPTION OF THE DRAWINGS

Embodiments of the invention will now be described, by way of example, with reference to the accompanying drawings in which:

FIG. 1 schematically illustrates a mobile telecommunication system of a type to which the invention is applicable;

FIG. 2 is an overview of a key derivation procedure which may be applied in the system shown in FIG. 1;

FIG. 3 is a block diagram illustrating the main components of a base station forming part of the system shown in FIG. 1;

FIG. 4 is a block diagram illustrating the main components of a small cell gateway forming part of the system shown in FIG. 1;

FIG. 5 is a block diagram illustrating the main components of a mobility management entity forming part of the system shown in FIG. 1; and

FIGS. 6 to 11 are exemplary timing diagrams illustrating methods performed by components of the system of FIG. 1 whilst carrying out embodiments of the invention.

### MODE(S) FOR CARRYING OUT THE INVENTION

### Overview

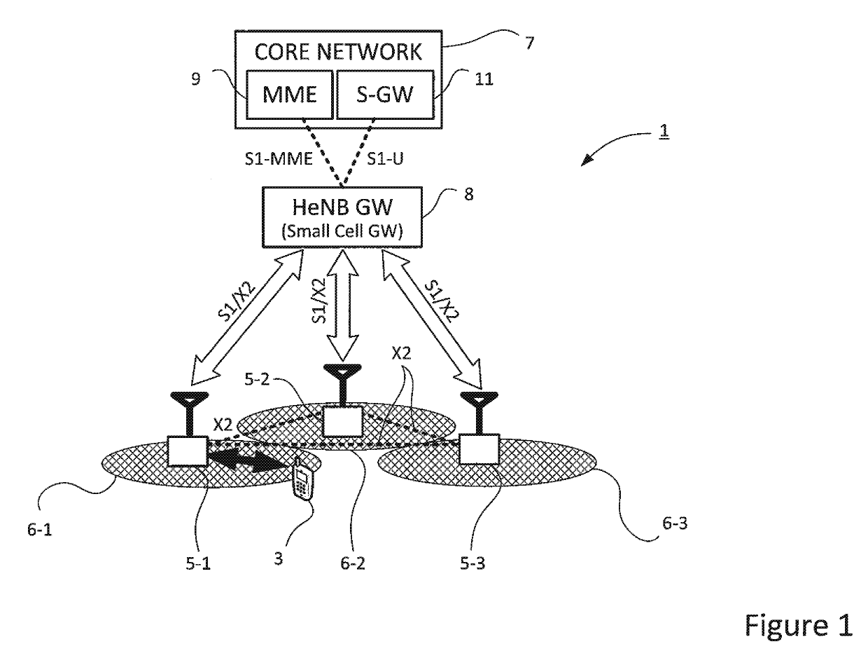

FIG. 1 schematically illustrates a mobile (cellular) telecommunication system 1 including a mobile communication device 3 comprising a mobile telephone (or other compatible user equipment) and a plurality of base stations 5-1 to 5-3, each of which operates an associated cell 6-1 to 6-3. Any of the base stations 5-1 to 5-3 may comprise a regular macro eNB and/or a small cell base station (such as Home evolved NodeB (HeNB), pico or femto base station, and/or the like).

In this example, the mobile communication device 3 is served via a cell 6-1 operated by one of the base stations 5-1. As those skilled in the art will appreciate, whilst one mobile communication device 3 and three base stations 5 are shown in FIG. 1 for illustration purposes, additional user equipment and/or base stations may be present in a deployed system.

Communication between the base stations 5 and a core network 7 is via a so-called ‘S1’ interface. The core network 7 includes a mobility management entity 9 (MME), a serving gateway (S-GW) 11 (and other communication entities such as a Packet Data Network (PDN) Gateway (PGW), which have been omitted for sake of simplicity). The MME 9 includes a so-called Access Security Management Entity (ASME), which is responsible for deriving the cryptographic keys (K_{eNB}/K_{eNB}*) to be used between the base stations 5 and user equipment 3 served by the base stations 5.

The HeNB GW 8 is connected to the MME 9 using the S1-MME interface and to the S-GW 11 using the S1-U interface, thus providing an appropriate control-plane (S1-MME) and user-plane (S1-U) connectivity for the mobile communication device 3 and the base stations 5. An ‘X2’ interface is also provided for communication between neighbouring base stations 5 to facilitate data exchange between them. In this example, a small cell gateway 8 (denoted ‘HeNB-GW’) is provided to implement the functionality of an X2 gateway, thus communications between the base stations 5 over the X2 interface are routed via the HeNB GW 8 (rather than routing them directly). The HeNB GW 8 may also be connected to the other networks (e.g. the core network 7), for operations and maintenance (OAM) purposes, and/or the like.

In this system, when the mobile communication device 3 needs to be handed over between two base stations 5 (e.g. base station 5-1 as the source base station and base station 5-2 as the target base station) that are connected to the same HeNB GW 8, the source and target base stations 5-1, 5-2 and the HeNB GW 8 are configured to carry out a handover procedure without requiring the MME 9 to provide a security context for the target base station 5-2 (which would normally be required in accordance with TS 36.401 and TS 36.413).

This is possible because the HeNB GW 8 is configured to obtain the current cryptographic key (K_{eNB}) and NCC directly from the source base station 5-1 (rather than from the MME 9). Specifically, the current K_{eNB} and NCC are obtained by the HeNB GW 8 from a message by the source base station 5-1 indicating that a handover is required. For example, the source base station 5-1 may include the current K_{eNB} and NCC in an appropriately formatted RRC container information element or transparent container information element (source eNB to target eNB transparent container information element). Further, the HeNB GW 8 is configured to provide the obtained information to the target base station 5-2 when it requests the target base station 5-2 to carry out the handover (e.g. by sending an appropriately formatted S1 signalling message). In this case, the target base station 5-2 is therefore able to derive the updated cryptographic key (K_{eNB}*) using the current K_{eNB} received from the source base station 5-1 (via the HeNB GW 8), and the information specific to the target base station (PCI and EARFCN), and to apply the updated key to the mobile communication device's 3 communications via the target base station 5-2 after completion of the requested handover.

Alternatively, the HeNB GW 8 may be configured to derive the target base station's 5-2 cryptographic key (instead of the target base station 5-2) using information obtained from the base stations 5 and/or the MME 9. Specifically, the HeNB GW 8 may be configured to obtain the applicable PCI and EARFCN information corresponding to the base station 5-2 from a message (e.g. an S1 signalling message) setting up the base station 5-2 for communication via the HeNB GW 8 (e.g. a message setting up an S1 connection for the base station 5-2). The HeNB GW 8 may also be configured to obtain the applicable PCI and EARFCN information corresponding to the base station 5-2 by communicating with an OAM entity. The HeNB GW 8 may also be configured to obtain and cache the current cryptographic key (K_{eNB}) used by the base station 5-1, e.g. from a message (such as an S1 signalling message, e.g. a ‘handover request’ message, a ‘path switch request’ message, and/or the like) sent by the MME 9 to the base station 5-1 (via the HeNB GW 8).

Therefore, using the obtained PCI and EARFCN information (obtained from the base station 5-1/5-2 or from the OAM entity) which uniquely identify the target base station 5-2, and also the source base station's 5-1 current cryptographic key (K_{eNB}) and NCC (obtained from the base station 5-1 or the MME 9), the HeNB GW 8 is able to derive the cryptographic key (K_{eNB}*) specific to the target base station and forward the derived cryptographic key (K_{eNB}*) to the target base station 5-2. For example, the HeNB GW 8 may be configured to provide the derived cryptographic key to the target base station 5-2 in a signalling message requesting the target base station 5-2 to carry out the handover initiated by the source base station 5-1. Thus when the target base station 5-2 complies with the HeNB GW's 8 handover request, it is able to apply the appropriate cryptographic key (new K_{eNB}) without having received any security context from the MME 9 (during the handover to the target base station 5-2) and without having to derive the target base station specific cryptographic key itself.

In a modification of this method, the source base station 5-1 may be configured to derive the target base station's 5-2 new K_{eNB} (since it already knows the target base station's 5-2 PCI and EARFCN information) and send the new K_{eNB} to the target base station 5-2 via the HeNB GW 8. In this case, the new K_{eNB} may be communicated between the base stations 5-1, 5-2 (via the HeNB GW 8) using an appropriately formatted RRC container information element or a transparent container information element (source eNB to target eNB transparent container information element) included in the signalling (e.g. S1 signalling) associated with the handover. Beneficially, with this modification, the target base station 5-2 is not required to calculate the K_{eNB}.

Thus, beneficially, the signalling between the base stations 5 and the core network 7 and/or between the HeNB GW 8 and the core network 7 can be reduced compared to conventional handover scenarios in which the MME 9 needs to provide the associated security context even when both the source base station 5-1 and the target base station 5-2 are connected to the same HeNB GW 8. Further, since the HeNB GW 8 does not need to wait for the receipt of any security context from the MME 9, it is possible to perform the handover procedure with less delay than using other methods involving the core network 7 and/or the MME 9.

### Key Handling in Handover

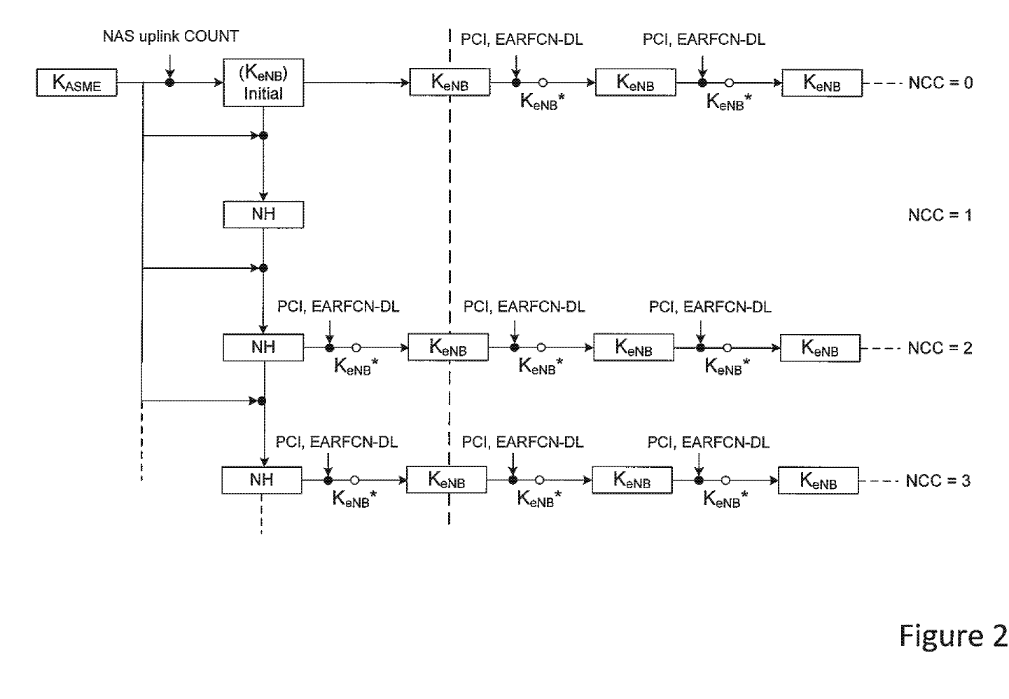

Before discussing the above scenarios in more detail, it is helpful to set out the general principle of key handling at handover in LTE systems. FIG. 2 gives an overview of the horizontal key derivation procedure which may be applied in the system shown in FIG. 1 in order to derive the target base station specific K_{eNB}* key when the mobile communication device 3 is being handed over between the base stations 5. Further details of the key derivation procedure can be found in section 7.2.8 of 3GPP TS 33.401 V12.10.0, the contents of which are hereby incorporated by reference.

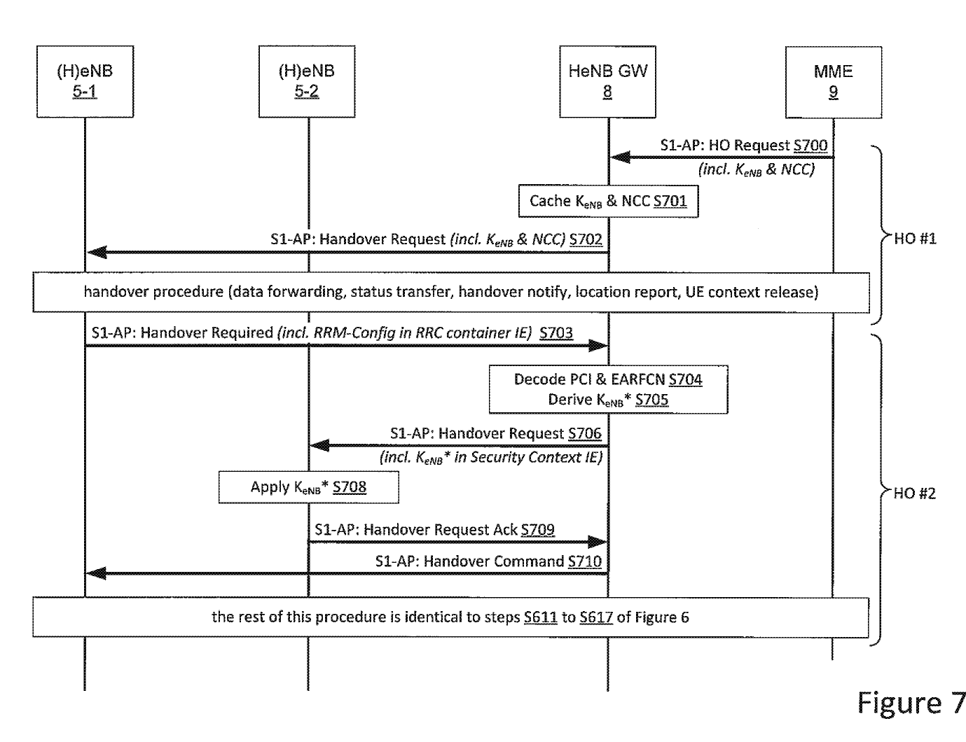

The general principle of key handling at handovers is depicted in FIG. 2, which corresponds to FIG. 7.2.8.1-1 of 3GPP TS 33.401. The following is an outline of the key handling model to clarify the structure of the key derivations. Sections 7.2.8.3 and 7.2.8.4 of 3GPP TS 33.401 V12.10.0 provide a more detailed specification, the contents of which are summarised below.

Whenever an initial AS security context needs to be established between the mobile communication device 3 and a base station 5, the MME 9 and the mobile communication device 3 derive a K_{eNB} and a Next Hop parameter (NH). The K_{eNB} and the NH are derived from the K_{ASME} stored at the MME 9. A NH Chaining Counter (NCC) is associated with each K_{eNB} and NH parameter. Every K_{eNB} is associated with the NCC corresponding to the NH value from which it was derived. At initial setup, the K_{eNB} is derived directly from the K_{ASME}, and it is then considered to be associated with a virtual NH parameter with NCC value equal to zero. At initial setup, the derived NH value is associated with the NCC value one.

The MME 9 does not send the NH value to the base station 5 at the initial connection setup. Instead, the base station 5 initialises the NCC value to zero after receiving an S1-AP Initial Context Setup Request message. According to TS 33.401, the MME 9 always computes a fresh {NH, NCC} pair that is given to the target base station 5. An implication of this is that the first {NH, NCC} pair will never be used to derive a K_{eNB}. It only serves as an initial value for the NH chain.

The mobile communication device 3 and the base station 5 use the K_{eNB} to secure the communication between each other. On handovers, the basis for the K_{eNB} that will be used between the mobile communication device 3 and the target base station 5, called K_{eNB}*, is derived from either the currently active K_{eNB} or from the NH parameter. If K_{eNB}* is derived from the currently active K_{eNB} this is referred to as a horizontal key derivation and if the K_{eNB}* is derived from the NH parameter the derivation is referred to as a vertical key derivation. On handovers with vertical key derivation the NH is further bound to the target PCI and its (downlink) frequency EARFCN before it is taken into use as the K_{eNB} in the target base station 5. On handovers with horizontal key derivation the currently active K_{eNB} is further bound to the target PCI and its (downlink) frequency EARFCN before it is taken into use as the K_{eNB} in the target base station 5.

As NH parameters are only computable by the mobile communication device 3 and the MME 9, the NH parameters are provided to the base stations 5 from the MME 9 in such a way that forward security can be achieved.

As part of the handover procedure, the (target) base station 5 derives the K_{eNB}* using its PCI, its (downlink) frequency EARFCN, and either the NH or the current K_{eNB} depending on the following criteria: the base station 5 uses the NH for deriving K_{eNB}* if an unused {NH, NCC} pair is available in the base station 5 (vertical key derivation), otherwise if no unused {NH, NCC} pair is available in the base station 5, the base station 5 derives K_{eNB}* from the current K_{eNB} (horizontal key derivation). The base station 5 uses the derived K_{eNB}* as the K_{eNB} after handover. The base station 5 sends the NCC used for K_{eNB}* derivation to the mobile communication device 3 in a HO Command message so that the mobile communication device 3 can also derive the same the K_{eNB}* and hence the mobile communication device 3 is able to continue communicating via the base station 5 after the handover.

The mobile communication device 3 checks whether the received NCC value (in the HO Command message from target base station 5) is equal to the NCC value associated with the currently active K_{eNB}. If the received and current NCC values are equal, the mobile communication device 3 derives the K_{eNB}* from the currently active K_{eNB} and the target PCI and (downlink) frequency EARFCN using the key derivation function illustrated in FIG. 2.

However, if the mobile communication device 3 received an NCC value that is different to the NCC associated with the currently active K_{eNB}, the mobile communication device 3 first synchronises the locally kept NH parameter by computing the function defined in Annex A.4 of TS 33.401 iteratively (increasing the NCC value until it matches the NCC value received from the base station 5 in the HO command message). When the NCC values match, the mobile communication device 3 computes the K_{eNB}* from the synchronised NH parameter, the target PCI, and the (downlink) frequency EARFCN.

In summary, following either of the above described procedures, the mobile communication device 3 is able to derive and use the appropriate target base station specific K_{eNB}* for communicating with the target base station 5 after the handover.

### Base Station

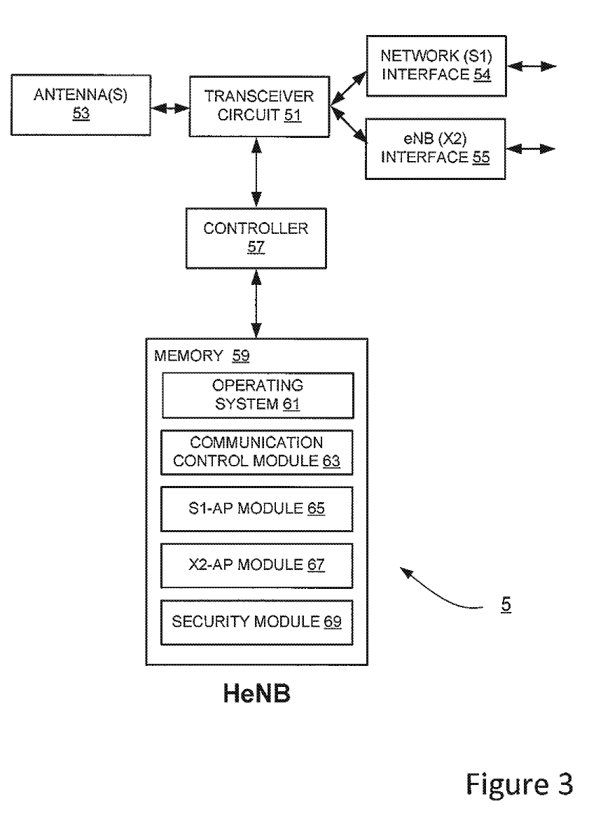

FIG. 3 is a block diagram illustrating the main components of one of the base stations 5 shown in FIG. 1, such as the source base station 5-1. As shown, the base station 5 includes transceiver circuit 51 which is operable to transmit signals to, and to receive signals from, the mobile communication device 3 via at least one antenna 53. The base station 5 is also operable to transmit signals to and to receive signals from nodes in the core network 7 (such as the MME 9 or the SGW 11), either directly or via a small cell gateway (e.g. the HeNB GW 8), using a network (S1) interface 54. The base station 5 is also operable to transmit signals to and to receive signals from other base stations (macro or small) either directly or via the HeNB GW 8 using an eNB (X2) interface 55. The operation of the transceiver circuit 51 is controlled by a controller 57 in accordance with software stored in memory 59. The software includes, among other things, an operating system 61, a communication control module 63, an S1-AP module 65, an X2-AP module 67, and a security module 69.

The communication control module 63 controls communications between the base station 5 and the mobile communication device 3, and between the base station 5 and the network devices such as the MME 9, SGW 11, and other base stations 5 (e.g. via the HeNB GW 8).

The S1-AP module 65 handles S1 signalling (e.g. generates, sends, and receives messages/PDUs formatted in accordance with the S1 protocol) between the base station 5 and the MME 9 (via the HeNB GW 8).

The X2-AP module 67 handles X2 signalling (e.g. generates, sends, and receives messages/PDUs formatted in accordance with the X2 application protocol) between the base station 5 and other (target) base stations, either directly or via the HeNB GW 8.

The security module 69 is responsible for securing communications via the base station 5 (e.g. between the core network 7 and user equipment 3). When the base station 5 is a handover target, the security module 69 obtains (e.g. via the S1-AP module 65) parameters (e.g. one or more of: Ic_{NB}/R_{eNB*}, NCC, PCI, and EARFCN) from the source base station and/or the HeNB GW 8, and using the obtained parameters, the security module 69 derives/applies an associated cryptographic key for securing communications via the base station 5. When the base station 5 is a handover source, the security module 69 provides (e.g. via the S1-AP module 65) parameters (e.g. one or more of: K_{eNB}/K_{eNB}*, NCC, PCI, and EARFCN) for deriving an associated cryptographic key for securing communications via the target base station.

### Small Cell Gateway

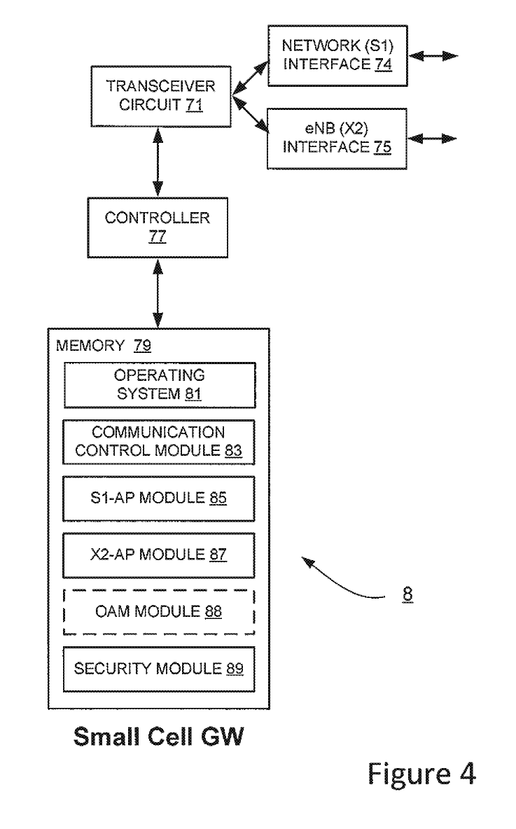

FIG. 4 is a block diagram illustrating the main components of the HeNB GW 8 shown in FIG. 1. As shown, the HeNB GW 8 includes transceiver circuit 71 which is operable to transmit signals to, and to receive signals from, core network entities (e.g. the MME 9 and/or the S-GW 11) via a network (S1) interface 74, and which is operable to transmit signals to, and to receive signals from, base stations 5 via an eNB (X2) interface 75. The operation of the transceiver circuit 71 is controlled by a controller 77 in accordance with software stored in memory 79. The software includes, among other things, an operating system 81, a communication control module 83, an S1-AP module 85, an X2-AP module 87, an optional operations and maintenance (OAM) module 88, and a security module 89.

The communication control module 83 is operable to control communications between the HeNB GW 8 and the core network via the core network interface 74 and between the HeNB GW 8 and the base stations 5 via the eNB interface 75.

The SE-AP module 85 handles S1 signalling (e.g. generates, sends, and receives messages/PDUs formatted in accordance with the S1 protocol) between the HeNB GW 8 and the MME 9, and between the HeNB GW 8 and the connected base stations 5.

The X2-AP module 87 handles X2 signalling (e.g. generates, sends, and receives messages/PDUs formatted in accordance with the X2 application protocol) between the base station 5 and the HeNB GW 8.

If present, the OAM module 88 communicates with an OAM entity (e.g. in the core network 7) in order to obtain information (e.g. PCI, EARFCN) associated with the base stations 5 connected to the HeNB GW 8, and to provide the obtained information to the security module 89, when appropriate.

The security module 89 is responsible for ensuring that the connected base stations' 5 communications (e.g. with the core network 7 and/or the user equipment 3) are secured (encrypted using an appropriate cryptographic key). In a handover scenario managed by the HeNB GW 8 without involving the MME 9, the security module 89 obtains (e.g. via the S1-AP module 85) from the source base station parameters (e.g. one or more of: K_{eNB}/K_{eNB}*, NCC, PCI, and EARFCN) required for deriving an associated cryptographic key for securing communications via the target base station. Some of this information (e.g. current K_{eNB}, NCC) may also be obtained from memory 79, e.g. if previously obtained from the MME 9 and cached by the HeNB GW 8 locally. The security module 89 may be configured to derive the associated cryptographic key itself (in which case it provides the derived cryptographic key, K_{eNB}*, to the target base station) or to provide the obtained parameters (e.g. one or more of: K_{eNB}/K_{eNB}*, NCC, PCI, and EARFCN) for deriving the associated cryptographic key at the target base station.

### Mobility Management Entity

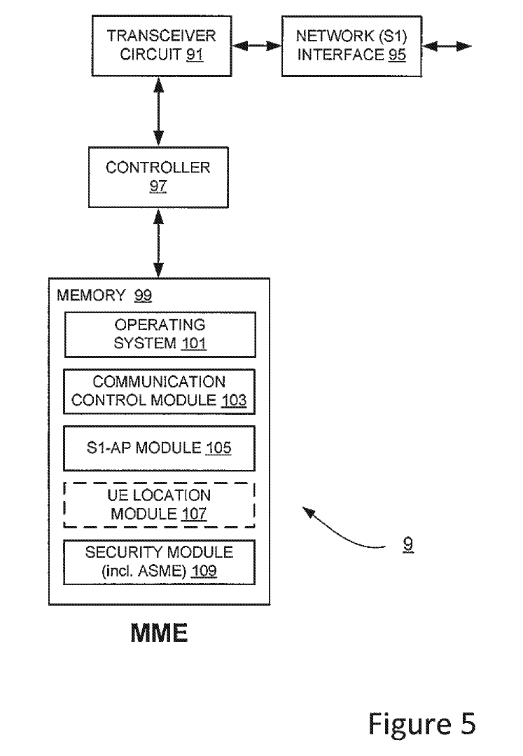

FIG. 5 is a block diagram illustrating the main components of the MME 9 shown in FIG. 1. As shown, the MME 9 includes transceiver circuitry 91 which is operable to transmit signals to, and to receive signals from, other network nodes such as the mobile communication device 3, the base stations 5, and/or the HeNB GW 8 via a network (S1) interface 95. The operation of the transceiver circuit 91 is controlled by a controller 97 in accordance with software stored in memory 79. The software includes, among other things, an operating system 101, a communication control module 103, an S1-AP module 105, an optional UE location module 107, and a security module 109.

The communication control module 103 is operable to control communications between the MME 9 and the HeNB GW 8, the base stations 5, and the mobile communication device 3 via the network interface 95.

The S1-AP module 105 handles S1 signalling (e.g. generates, sends, and receives messages/PDUs formatted in accordance with the S1 protocol) between the MME 9 and the HeNB GW 8, and between the MME 9 and the base stations 5.

If present, the UE location module 107 is responsible for keeping track of the current locations of each mobile communication device 3 served by the MME 9. The UE location module 107 is configured to obtain (e.g. via the S1-AP module 105) location updates from the target base station 5 to which the mobile communication device 3 is handed over. Such location updates may be provided by the target base station 5 using any suitable signalling message, e.g. a ‘Handover Notify’ and/or a ‘Location Report’ message formatted in accordance with the S1 protocol.

The security module 109 is responsible for ensuring that communications between the network nodes (e.g. the mobile communication device 3, the base stations 5, and the HeNB GW 8) are secure (encrypted). The security module 109 includes the so-called Access Security Management Entity (ASME) functionality as specified in the relevant 3GPP standards. When the MME 9 receives a handover required message from the HeNB GW 8 or the source base station 5, the security module 109 provides the so-called security context to the target base station identified in the handover required message. However, when the MME 9 receives a location update from the HeNB GW 8 indicating that a mobile communication device 3 has been handed over to a new base station 5 (without receiving an associated handover required message), the security module 109/ASME functionality does not need to provide a security context to the new base station, since in this case the base stations 5 and the HeNB GW 8 are able to derive the required cryptographic key without involving the MME 9.

In the above description, the base station 5, the HeNB GW 8, and the MME 9 are each described for ease of understanding as having a number of discrete modules (such as the communication control modules, the S1-AP modules, and the security modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

### Operation—First Embodiment

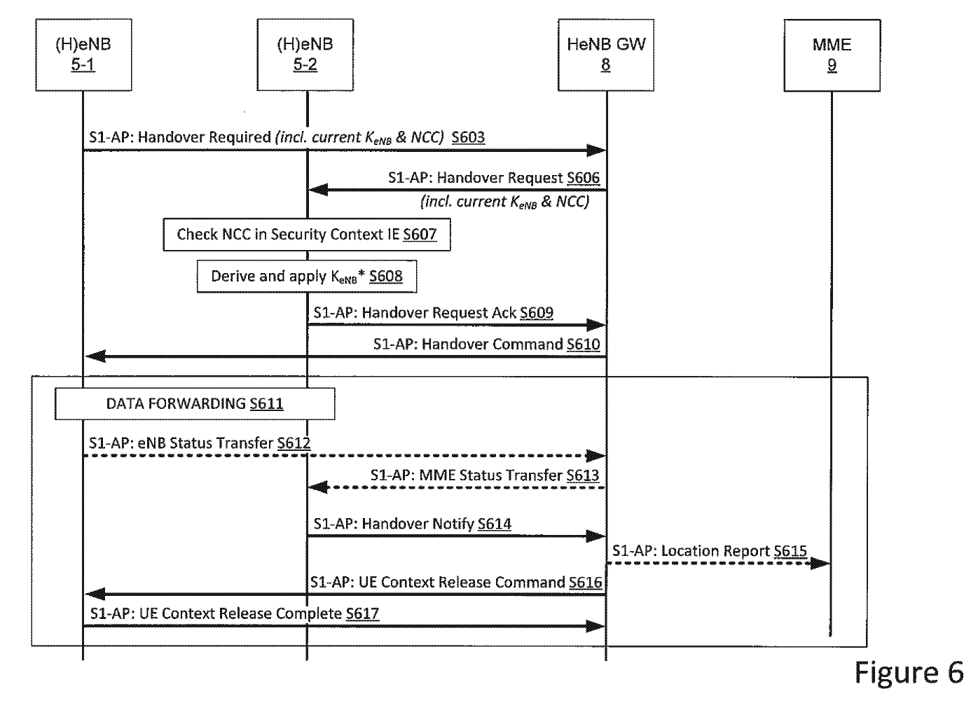

FIG. 6 is an exemplary timing diagram illustrating a method performed by components of the mobile telecommunication system 1 of FIG. 1 whilst carrying out an embodiment of the invention.

The process begins in step S603, in which the source base station 5-1 indicates to the HeNB GW 8 that the mobile communication device 3 needs to be handed over to the target base station 5-2. The source base station 5-1 does so by generating (using its S1-AP module 65) and sending an appropriately formatted signalling message (e.g. a ‘Handover Required’ S1-AP message) to the HeNB GW 8. The source base station 5-1 includes in this message the security context (i.e. the current K_{eNB} and NCC) applicable at the source base station 5-1. The security context may be included in e.g. any suitable portion of the message sent at S603, such as an extension portion that can be understood by the target base station 5-2. The ‘extension’ portion in this example comprises an appropriately formatted RRC container information element or a transparent container information element (e.g. a ‘source eNB to target eNB transparent container’ information element). Since the source base station 5-1 cannot tell whether the target base station 5-2 is also connected to the same HeNB GW 8, thus it is not possible to tell in advance whether the handover will involve the MME 9 or not, the HeNB GW 8 includes in this message the ‘regular’ security context information element (IE) instead of the MME 9, in addition to including the current K_{eNB} and NCC in the extension portion by source base station 5-1.

In response to this message indicating that a handover is required, the HeNB GW generates (using its S1-AP module 85) and sends, in step S606, an appropriately formatted signalling message (e.g. a ‘Handover Request’ S1-AP message) requesting the target base station 5-2 to perform a handover for the mobile communication device 3 (identified in the request), to the target base station's 5-2 The HeNB GW 8 also includes in this message the applicable security context (i.e. the current K_{eNB} and NCC) received from the source base station 5-1 at S603—for example, by adding the RRC container information element or transparent container information element received from the source base station 5-1.

In step S607, the target base station 5-2 (using its S1-AP module 65) checks and compares the NCC value in the security context IE (included in the message received at S606) to determine whether it is the same as the NCC value included in the extended part of the message from the HeNB GW 8. If the NCC values are the same, the target base station 5-2 ignores any K_{eNB} included in the security context IE and adopts the K_{eNB} included in the extended part. If the NCC values are different, the target base station 5-2 adopts the K_{eNB} included with the most recent NCC and ignores any K_{eNB} included with the other NCC.

Next, as shown in step S608, the target base station 5-2 (using its security module 69) derives the K_{eNB}* (target base station specific K_{eNB}*) to be applied (i.e. after the handover has been successfully completed) for the base station's 5-2 subsequent communications with the mobile communication device 3.

If the target base station 5-2 is able to comply with the handover request, then it generates (using its S1-AP module 65) and sends, in step S609, an appropriately formatted acknowledgement message (e.g. a ‘Handover Request Ack’ S1-AP message) to the HeNB GW 8.

In step S610, the HeNB GW 8 forwards the target base station's 5-2 handover command to the source base station 5-1 (using e.g. an appropriately formatted S1-AP message).

As generally shown in step S611, the source base station 5-1 forwards (using its S1-AP module 65) to the target base station 5-2 any remaining downlink data yet to be sent to the mobile communication device 3.

Optionally, as illustrated in step S612, the source base station 5-1 may generate (using e.g. its S1-AP module 65) and send, to the HeNB GW 8, an appropriately formatted S1-AP message (e.g. an ‘eNB Status Transfer’ S1 message) transferring the uplink receiver status and the downlink transmitter status from the source base station 5-1 to the target base station 5-2. In response to this message, on behalf of the MME 9, the HeNB GW 8 generates (using e.g. its S1-AP module 85) and sends, in step S613, an appropriately formatted S1-AP message (e.g. an ‘MME Status Transfer’ S1 message) to the target base station 5-2, completing the transfer of the uplink receiver status and the downlink transmitter status from the source base station 5-1 to the target base station 5-2.

Since non-handover related S1 interface procedures are generally paused while a handover is ongoing (i.e. from the time that a Handover Required message has been received by the HeNB GW 8, at S603), the target base station 5-2 notifies the HeNB GW 8, in step S614, that the handover procedure has succeeded by generating and sending an appropriately formatted ‘Handover Notify’ S1-AP message so that the HeNB GW 8 can continue its previously paused S1 interface procedures, if any. Although not shown in FIG. 6, if the handover fails, the target base station 5-2 generates and sends a ‘Handover Failure’ S1-AP message instead.

Although this step is optional, after the handover has been successfully completed, the HeNB GW 8 may generate (e.g. using its S1-AP module 85) and send, in step S615, an appropriately formatted S1-AP message (e.g. a ‘Location Report’ S1-AP message) to the MME 9 informing the MME 9 about the mobile communication device's 3 current location (i.e. the cell of the target base station 5-2 identified by its CPI). Upon receipt of the message at S615, the MME 9 updates the information maintained for this mobile communication device 3 in its UE location module 107, or example by adding the received CPI (and discarding any previously stored CPI).

Finally, the HeNB GW 8 generates (e.g. using its S1-AP module 85) and sends, in step S616, an appropriately formatted S1-AP message (e.g. a ‘UE Context Release Command’ S1-AP message) to the source base station 5-1 instructing the source base station 5-1 to clear any context associated with the mobile communication device 3 that has been handed over to the target base station 5-2. In step S617, the source base station 5-1 confirms the release of the context associated with the mobile communication device 3 by sending an appropriately formatted message (e.g. a ‘UE Context Release Complete’ S1-AP message) to the HeNB GW 8.

Accordingly, it is possible to carry out a handover from the source base station 5-1 to the target base station 5-2 without involving the MME 9 (other than sending a location update after the handover has been completed), which beneficially reduces the signalling required between the core network 7 and the base stations 5.

### Operation—Second Embodiment

FIG. 7 is an exemplary timing diagram illustrating a method performed by components of the mobile telecommunication system 1 of FIG. 1 whilst carrying out an embodiment of the invention. In this example, the HeNB GW 8 is configured to derive the target base station specific K_{eNB}* instead of the target base station 5-2.

The procedure begins in step S700, in which the MME 9 generates (using its S1-AP module 105) and sends an appropriately formatted message towards the base station 5-1 (not currently serving the mobile device 3), instructing the base station 5-1 to perform a handover (‘HO’) of the mobile device 3 from another base station currently serving the mobile device 3. In other words, the MME 9 requests the base station 5-1 to become the serving base station for the mobile device 3. In this example, the MME's 9 message comprises a ‘Handover Request’ message, although it may also comprise a ‘Path Switch Request Acknowledge’ message and/or the like.

As generally shown in step S701, the HeNB GW 8 is configured to cache (i.e. store in memory 79) the current K_{eNB} and NCC that are to be used by the base station 5-1 following the handover (denoted ‘HO #1’ in FIG. 7) for securing communications with the mobile device 3. In this example, the current K_{eNB} and NCC are included (e.g. in a security context IE) in the message received from the MME 9 at S700. It will be appreciated that the HeNB GW 8 may be configured to cache the corresponding K_{eNB} and NCC for each connected base station 5 when the K_{eNB} and NCC are transferred via the HeNB GW 8, i.e. whenever a handover request, path switch request acknowledge message, and/or the like is received by the HeNB GW 8 for a connected base station 5.

In step S702, the HeNB GW 8 communicates the MME's 9 message to the base station 5-1 instructing the base station 5-1 to initiate handover (or path switch) procedures from the base station currently serving the mobile device 3. The message at S702 also includes the current K_{eNB} and NCC (e.g. in a security context IE), obtained from the MME 9, for securing subsequent communications with the mobile device 3.

Although not shown in details in FIG. 7, before proceeding to the next step (S703), the new serving base station 5-1 and the previous serving base station complete the handover procedure by performing appropriate data forwarding, status transfer, handover notification, location reporting (towards the MME), and UE context release procedures, as specified in the relevant standards.

The remaining steps of this embodiment form part of a subsequent handover procedure (denoted ‘HO #2’ in FIG. 7) for the mobile device 3, during which the current serving base station 5-1 (acting as a source base station) initiates handover of the mobile device 3 to the base station 5-2 (acting as a target base station).

As can be seen, step S703 generally corresponds to step S603 described with reference to FIG. 6. However, in this case the HeNB GW 8 is configured to decode, in step S704, an information element comprising radio resource management (RRM) configuration (e.g. an ‘RRM-Config’ information element, which may form part of e.g. a ‘HandoverPreparationInformation’ information element). The RRM configuration is included in the handover required message sent by the source base station 5-1 (for the target base station 5-2), e.g. in a suitable RRC container. In this example, the ‘RRM-Config’ information element conveys the PCI and EARFCN of the target cell (normally intended for the target base station 5-2 for identifying the cell and channel to be used by the mobile communication device 3 after handover). It will be appreciated that the HeNB GW 8 may be configured to decode (e.g. as shown in step S704) the RRM configuration every time it receives a handover required message from one of the base stations connected to the HeNB GW 8.

As generally shown in step S705, the HeNB GW 8 (using its security module 89) is therefore able to derive the K_{eNB}* (target base station specific K_{eNB}*) to be applied by the target base station 5-2 (i.e. after the handover has been successfully completed) for the target base station's 5-2 subsequent communications with the mobile communication device 3. Specifically, the security module 89 (of the HeNB GW 8) is configured to derive the K_{eNB}*, in accordance with the key derivation procedure described with reference to FIG. 2, using the PCI and EARFCN of the target cell (included in the ‘RRM-Config’ IE from the source base station 5-1) and the current K_{eNB} and NCC (stored in memory 79).

After the target base station specific K_{eNB}* has been derived at step S705, the HeNB GW 8 generates (using its S1-AP module 65) and sends, in step S706, an appropriately formatted signalling message (e.g. a ‘Handover Request’ S1-AP message) requesting the target base station 5-2 to perform a handover for the mobile communication device 3 (identified in the request) using an appropriate identifier (e.g. a ‘Global eNB ID’) associated with the target base station 5-2 (indicated by the source base station 5-1 at S703). The HeNB GW 8 also includes in this message the K_{eNB}* it has derived at step S705.

Next, as shown in step S708, the target base station 5-2 (using its security module 69) starts applying the received K_{eNB}* for the base station's 5-2 communications with the mobile communication device 3 (following successful completion of the handover). Specifically, using the received K_{eNB}* and based on the key derivation procedure illustrated in FIG. 2, the target base station 5-2 calculates a new K_{eNB} for securing communications with the mobile communication device 3.

Steps S709 and S710 correspond to steps S609 and S610 of FIG. 6, respectively; hence their description is omitted herein for sake of simplicity. The remaining of this embodiment is identical to steps S611 to S617 described with reference to FIG. 6.

### Operation—Third Embodiment

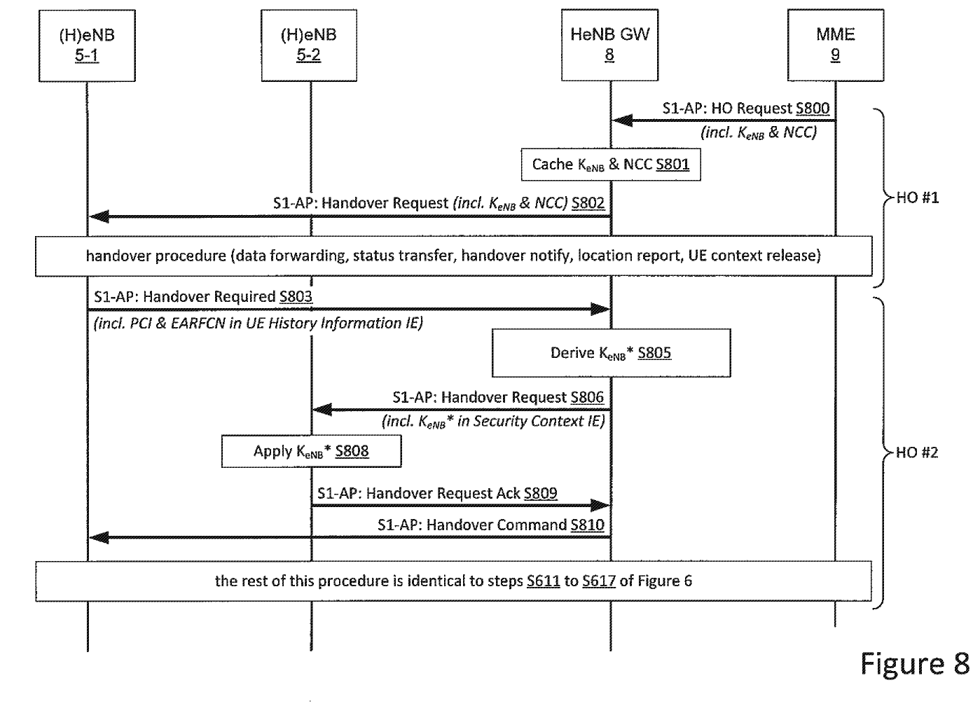

FIG. 8 is an exemplary timing diagram illustrating a method performed by components of the mobile telecommunication system 1 of FIG. 1 whilst carrying out an embodiment of the invention. In this example, the HeNB GW 8 is configured to derive the target base station specific K_{eNB}* instead of the target base station 5-2, based on UE history information provided by the source base station 5-1.

The steps forming part of the first handover procedure (HO #1), i.e. steps S800 to S802 and the subsequent “handover procedure”, are identical to the HO #1 procedure illustrated in FIG. 7, thus they will not be discussed here again. However, the subsequent handover procedure (HO #2) of this embodiment is different to the corresponding procedure of the second embodiment described above.

Step S803 (the first step of the HO #2 procedure) generally corresponds to step S703 described with reference to FIG. 7. However, in this case the HeNB GW 8 is configured to obtain the PCI and EARFCN of the target base station 5-2 from one or more information element included in the handover required message, rather than by decoding the RRM-Config IE/RRC container IE included therein.

In this example, the source base station 5-1 is configured to include the PCI and EARFCN in one or more suitable information element, e.g. in a ‘UE History Information’ IE and/or a ‘Last Visited E-UTRAN Cell Information’ IE included in the handover required message (sent to the HeNB GW 8 at S803). Specifically, the source base station 5-1 (using its S1-AP module 85) adapts the history/cell information IE by adding an indication for the HeNB GW 8 (e.g. by setting the ‘Cell Type’ IE to a predetermined value) that the history/cell information IE includes the values of the PCI and EARFCN (rather than actual UE/cell history). In this example, the source base station 5-1 includes the PCI in a ‘Global Cell ID’ IE of the ‘Last Visited E-UTRAN Cell Information’ IE, and includes the EARFCN in a ‘Time UE stayed in Cell’ IE of the ‘Last Visited E-UTRAN Cell Information’ IE. Some of the information elements that may be adapted to convey the PCI and EARFCN to the HeNB GW 8 are described in sections 9.2.1.42 to 9.2.1.43b of TS 33.413, the contents of which are included herein by reference.

Advantageously, in this case, there is no need for the HeNB GW 8 to decode (as in step S704 of FIG. 7) the RRC container included in the message at S803 and look for any ‘RRM-Config’ information element in the decoded RRC container because the PCI and EARFCN are included in one or more predetermined (non-RRC encoded) information element of the S1-AP message. This in turn may beneficially reduce the processing required at the HeNB GW 8.

The HeNB GW 8 is also configured to cache the current K_{eNB} and NCC, e.g. as shown in step S801. Therefore, as generally shown in step S805, the HeNB GW 8 (using its security module 89) is able to derive the K_{eNB}* (target base station specific K_{eNB}*) to be applied by the target base station 5-2 for the target base station's 5-2 subsequent communications with the mobile communication device 3 (i.e. after successful completion of the HO #2 procedure).

After the target base station specific K_{eNB}* has been derived at step S805, the HeNB GW 8 generates (using its S1-AP module 65) and sends, in step S806, an appropriately formatted signalling message (e.g. a ‘Handover Request’ S1-AP message) requesting the target base station 5-2 (identified by an appropriate identifier, e.g. a ‘Global eNB ID’, associated with the eNB 5-2) to perform a handover for the mobile communication device 3 (identified in the request, e.g. using an associated. UE identifier). The HeNB GW 8 also includes in this message the K_{eNB}* it has derived at step S805.

Next, as shown in step S808, the target base station 5-2 (using its security module 69) starts applying the received K_{eNB}* for the base station's 5-2 communications with the mobile communication device 3 (following successful completion of the handover procedure, i.e. HO #2). Specifically, using the received K_{eNB}* and based on the key derivation procedure illustrated in FIG. 2, the target base station 5-2 calculates a new K_{eNB} for securing communications with the mobile communication device 3.

Steps S809 and S810 correspond to steps S609 and S610 of FIG. 6, respectively; hence their description is omitted herein for sake of simplicity. The remaining of this embodiment is identical to steps S611 to S617 described with reference to FIG. 6.

### Operation—Fourth Embodiment

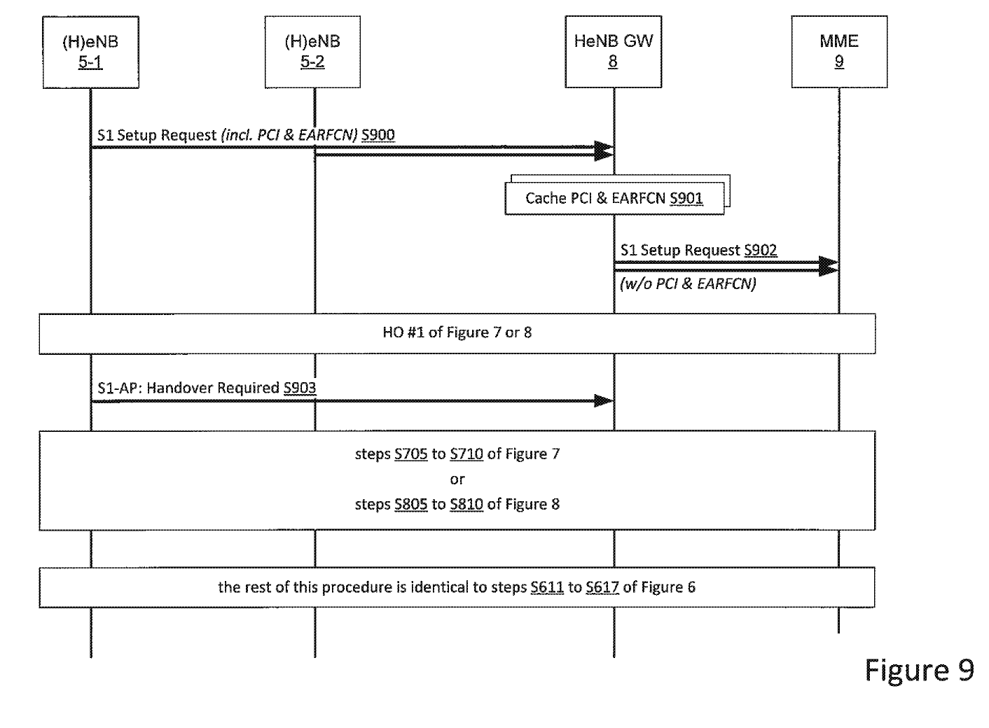

FIG. 9 is an exemplary timing diagram illustrating a method performed by components of the mobile telecommunication system 1 of FIG. 1 whilst carrying out an embodiment of the invention. In this example, the HeNB GW 8 is configured to obtain some of the information (e.g. the target base station's PCI and EARFCN) needed for deriving the K_{eNB}* from a message setting up the base station to operate with the HeNB GW 8.

Initially, the base stations 5-1, 5-2 register with the HeNB GW 8 and MME 9, by generating (using their S1-AP module 65) and sending an appropriately formatted message requesting S1 connection setting up the base station 5 to operate with the HeNB GW 8 and MME 9. This is illustrated generally at step S900. As shown in step S901, the HeNB GW 8 stores (caches) the PCI and EARFCN information for each base station 5-1, 5-2 that has sent a S1 setup request. Although not shown in FIG. 9, the HeNB GW 8 may also generate and send an appropriate confirmation message to each base station 5-1, 5-2 that has sent a S1 setup request, to reply the base station that the S1 setup has been successful.

In response to the setup request from the base stations 5-1, 5-2, the HeNB GW 8 generates (using its S1-AP module 65) and sends, in step S902, an appropriately formatted message (e.g. a standard ‘S1 Setup Request’ S1-AP message, i.e. without including the PCI and the EARFCN information) requesting the MME 9 to set up a respective S1 connection for the base stations 5-1, 5-2.

Following the S1 setup for each connected base station, the procedure of this embodiment continues with the HO #1 procedure (as described with reference to FIG. 7 above), which results in the mobile device 3 being served by the base station 5-1. However, when the base station 5-1 subsequently needs to hand over the mobile device 3 to a different base station, the base station 5-1 (now acting as the source base station) generates and sends, at step S903, an appropriately formatted signalling message (e.g. a ‘Handover Required’ S1-AP message) to the HeNB GW 8, requesting the base station 5-2 (acting as the target base station) to become the new serving base station for the mobile device 3. It will be appreciated that the source base station's 5-1 message at S903 may comprise a standard ‘Handover Required’ S1-AP message (e.g. in order to maintain backward compatibility), although it may also comprise a message as described above with reference to step S703 and/or step S803 above.

Next, the HeNB GW 8 (using its security module 89) derives the K_{eNB}* (target base station specific K_{eNB}*) to be applied by the target base station 5-2 for subsequent communications with the mobile communication device 3. Effectively, after step S903, the HeNB GW 8 may either proceed to step S705 or S805 and derive the K_{eNB}* (in accordance with the key derivation procedure described with reference to FIG. 2) using the PCI and EARFCN of the target cell (included in the setup request at S900) and the current K_{eNB} and NCC (stored in memory 79, following step S701 or S801 of the HO ∩1 procedure, as appropriate).

The remaining of this embodiment is identical to steps S611 to S617 described with reference to FIG. 6.

### Operation—Fifth Embodiment

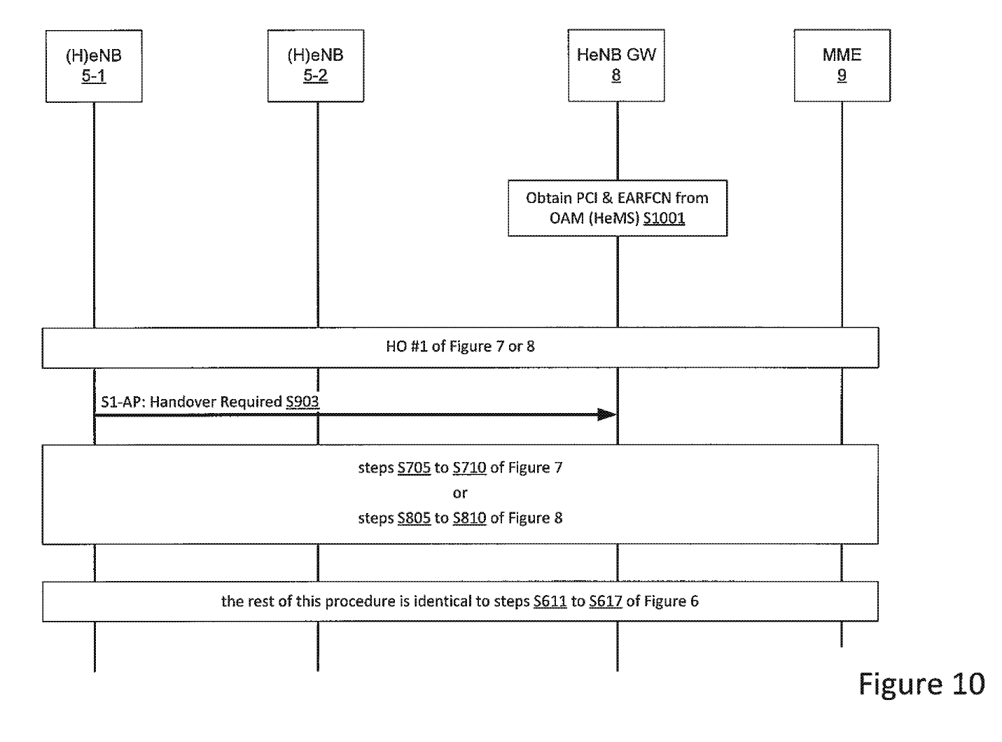

FIG. 10 is a modification of the timing diagram shown in FIG. 9. In this example, the HeNB GW 8 is configured to obtain some of the information (e.g. the target base station's PCI and EARFCN) needed for deriving the K_{eNB}* by communicating with an operation and maintenance (OAM) entity.

Specifically, e.g. instead of (or in addition to) processing an S1 setup request for each base station 5 (as described with reference to steps S900 to S902 of FIG. 9), the HeNB GW 8 obtains the PCI and EARFCN needed for deriving the K_{eNB}* from the OAM entity. For example, the HeNB GW 8 may obtain the PCI and EARFCN information based on a global cell ID (or IDs) associated with each base station 5 (to be) connected to this HeNB GW 8. It will be appreciated that the HeNB GW 8 and the OAM entity may carry out a request-response procedure and/or the like, either prior to connecting the base stations 5 to the HeNB GW 8 or as part of setting up the base stations 5 with the network (e.g. as part of step S901 if a preceding setup request does not include the PCI and EARFCN information).

Beneficially, in this case the base stations 5 do not need to include their PCI and EARFCN in the messages (e.g. as in step S900) sent to the HeNB GW 8, which in turn improves backward compatibility and compliance with existing standards.

The remaining of this embodiment is identical to that of FIG. 9; hence the description of the subsequent steps is omitted herein for sake of simplicity.

### Operation—Sixth Embodiment

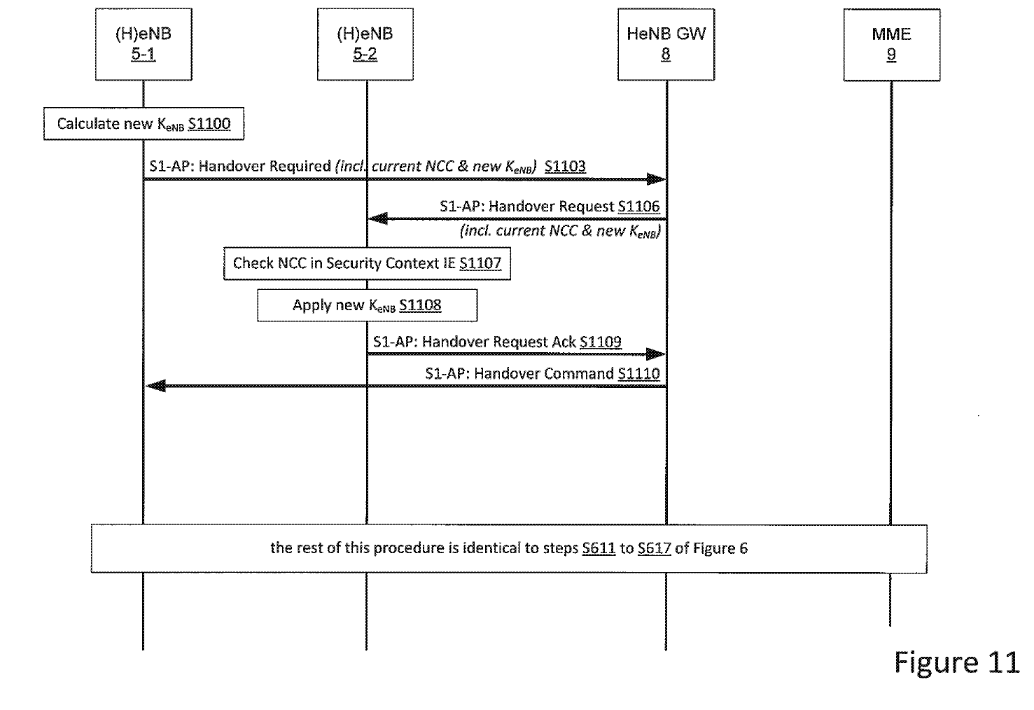

FIG. 11 is an exemplary timing diagram illustrating a method performed by components of the mobile telecommunication system 1 of FIG. 1 whilst carrying out an embodiment of the invention. In this example, the source base station 5-1 is configured to derive the target base station specific new K_{eNB} instead of the target base station 5-2.

The procedure begins in step S1100, in which the source base station 5-1 generates (using its security module 69) a new K_{eNB} to be used by the target base station 5-2 in its communications with the mobile communication device 3 following a handover of the mobile communication device 3 from the source base station 5-1 to the target base station 5-2.

Next, the source base station 5-1 generates (using its S1-AP module 65) and sends, in step S1103, an appropriately formatted signalling message (e.g. a ‘Handover Required’ S1-AP message) to the HeNB GW 8. The source base station 5-1 includes in this message the current NCC and the new K_{eNB} for the target base station 5-2. The current NCC and the new K_{eNB} may be included in e.g. any suitable portion of the message, such as an extension portion that can be understood by the target base station 5-2. The ‘extension’ portion in this example comprises an appropriately formatted RRC container information element or a transparent container information element (e.g. a ‘source eNB to target eNB transparent container’ information element). Similarly to step S603, the source base station 5-1 also includes in this message the ‘regular’ security context IE, in addition to including the current NCC and the new K_{eNB} in the extension portion of the message at S1103.

In response to this message, the HeNB GW 8 generates (using its S1-AP module 85) and sends, in step S1106, an appropriately formatted signalling message (e.g. a ‘Handover Request’ S1-AP message) requesting the target base station 5-2 to perform a handover for the mobile communication device 3 (identified in the request). The HeNB GW 8 also includes in this message the current NCC and the new K_{eNB} received from the source base station 5-1 at S1103—for example, by adding the RRC container information element or transparent container information element received from the source base station 5-1.

In step S1107, the target base station 5-2 (using its S1-AP module 65) checks and compares the NCC value in the security context IE (included in the message received at S1106) to determine whether it is the same as the NCC value included in the extended part of the message from the HeNB GW 8. If the NCC values are the same, the target base station 5-2 ignores any K_{eNB} included in the security context IE and adopts the new K_{eNB} included in the extended part.

Next, as generally shown in step S1108, the target base station 5-2 is set up for applying the new K_{eNB} for the base station's 5-2 subsequent communications with the mobile communication device 3 (i.e. after the handover has been successfully completed).

If the target base station 5-2 is able to comply with the handover request, then it generates (using its S1-AP module 65) and sends, in step S1109, an appropriately formatted acknowledgement message (e.g. a ‘Handover Request Ack’ S1-AP message) to the HeNB GW 8. In step S1110, the HeNB GW 8 forwards the target base station's 5-2 handover command to the source base station 5-1 (using e.g. an appropriately formatted S1-AP message).

The remaining of this embodiment is identical to steps S611 to S617 described with reference to FIG. 6.

### Benefits

In summary, e.g. as described above with reference to FIG. 6, when the target base station obtains the source base station's current K_{eNB} and the associated NCC (via the HeNB GW), the target base station can beneficially derive the required K_{eNB}*, using standard key derivation mechanisms (albeit without requiring involvement of the MME).

Alternatively, e.g. as described above with reference to FIGS. 7 to 10, when the HeNB GW obtains the target base station's PCI and EARFCN information (and the source base station's current K_{eNB} and the associated NCC), the HeNB GW is able to derive the K_{eNB}* and provide this K_{eNB}* to the target base station. In this case, there is no need for the target base station to process the source base station's K_{eNB} and NCC.

If the source base station is configured to derive the new K_{eNB} to be used by the target base station, and HeNB GW sends the new K_{eNB} (or the K_{eNB}*) to the target base station, it may be possible to reduce the processing required at the HeNB GW and the target base station compared to when the target base station's new K_{eNB} (or K_{eNB}*) is derived by the HeNB GW or the target base station, whilst involvement of the MME can still be avoided.

Finally, the above described handover techniques do not adversely affect the security or standards compliance of communications between the base stations and the mobile communication device because the communications can still be encrypted using the appropriate, target base station specific cryptographic key (K_{eNB}*), without requiring any input from the MME during the handover procedure.

### Modifications and Alternatives

A number of detailed embodiments have been described above. As those skilled in the art will appreciate, a number of modifications and alternatives can be made to the above embodiments whilst still benefiting from the inventions embodied therein.

In the above description of FIG. 1, each base station is described to be a (home) base station operating a small cell (e.g. a pico/femto cell). However, it will also be appreciated that the signalling techniques described in the present application can be employed between any types of base stations, including regular/macro base stations, connected to each other via a gateway (such as the HeNB GW).

It will also be appreciated that the source base station may be configured to derive the K_{eNB}* to be used by the target base station, in which case the source base station may send the target base station specific K_{eNB}* to the target base station (via the HeNB GW) using appropriately formatted S1-AP signalling (and/or using a suitable RRC container and/or a transparent container). This may beneficially result in a reduction of the processing required at the HeNB GW and the target base station compared to when the target base station's K_{eNB}* is derived by the HeNB GW or the target base station, whilst involvement of the MME can still be avoided.

In the above embodiments, the HeNB GW is described to send the security context (NCC-K_{eNB} pair) and/or the K_{eNB}* (or new K_{eNB}) to the target base station in an RRC container information element or a transparent ‘Source eNB to Target eNB’ container information element. However, it will be appreciated that the HeNB GW may send the security context (NCC-K_{eNB} pair) and/or the K_{eNB}* (or new K_{eNB}) to the target base station in any suitable information element of the handover request message. It will also be appreciated that the HeNB GW may send the security context (NCC-K_{eNB} pair) and/or the K_{eNB}* (or new K_{eNB}) to the target base station in a separate message, e.g. prior to (or after) sending the handover request message to the target base station.

Whilst the above exemplary embodiments have been described using specific S1-AP messages, it will be appreciated that different S1-AP messages may be used instead. Further, it will also be appreciated that a different protocol than X2-AP may be used between the base stations and the HeNB GW, for example any other suitable 3GPP protocol, and/or any suitable non-3GPP protocol, such as the Simple Network Management Protocol (SNMP) specified by the Internet Engineering Task Force (IETF) and/or the Technical Report 069 (TR-069) protocol specified by the Broadband Forum.

In the above embodiments, a mobile telephone based telecommunications system was described. As those skilled in the art will appreciate, the signalling techniques described in the present application can be employed in other communications system. Other communications nodes or devices may include user devices such as, for example, personal digital assistants, laptop computers, web browsers, etc. Further, one or more of the base stations may comprise access point(s) of a wireless local area network (WLAN) and/or the like.

In the embodiments described above, the base stations, the gateway, and the mobility management entity each include transceiver circuitry. Typically this circuitry will be formed by dedicated hardware circuits. However, in some embodiments, part of the transceiver circuitry may be implemented as software run by the corresponding controller.

In the above embodiments, a number of software modules were described. As those skilled in the art will appreciate, the software modules may be provided in compiled or un-compiled form and may be supplied to the base station or to the gateway as a signal over a computer network, or on a recording medium. Further, the functionality performed by part or all of this software may be performed using one or more dedicated hardware circuits. However, the use of software modules is preferred as it facilitates the updating of the base stations, the gateway, and the mobility management entity in order to update their functionalities.

The message for initiating a handover may comprise information for identifying a cell (e.g. a Physical Cell Identity, PCI) and information for identifying a frequency channel (e.g. an Evolved Universal Terrestrial Radio Access Absolute Radio Frequency Channel Number, EARFCN) of the further base station. For example, the information for identifying a cell and the information for identifying a frequency channel may be included in an RRC-encoded part of the message (e.g. in an ‘RRM-Config’ IE in an RRC container).

The information for identifying a cell (e.g. a PCI) and the information for identifying a frequency channel (e.g. an EARFCN) of the further base station may be included in one or more information elements (e.g. a ‘UE History information’ information element and/or a ‘Last Visited E-UTRAN Cell Information’ information element) configured to convey cell information between the base station and other nodes of the communication system.

The key for securing communications with the mobile communication device may comprise a key (K_{eNB}*) specific to the further base station.

The received key for securing communications with the mobile communication device may comprise a key (e.g. a K_{eNB}) specific to the further base station; and the base station may comprise means for deriving a further key (e.g. a K_{eNB}*) specific to the base station using the received key and the associated counter.

The base station may comprise at least one of a macro base station, a pico base station, a femto base station, and a home base station operating in accordance with the Long Term Evolution (LTE) set of standards.

The received key for securing communications with the mobile communication device may be specific to the first base station, and the information for deriving a further key may comprise the received key and the associated counter.

The key for securing communications with the mobile communication device may be specific to the second base station, and the information for deriving a further key may comprise the received key.

The gateway apparatus may further comprise means for obtaining information for identifying a cell (e.g. a Physical Cell Identity, PCI) and information for identifying a frequency channel (e.g. an Evolved Universal Terrestrial Radio Access Absolute Radio Frequency Channel Number, EARFCN) of the second base station. In this case, the means for obtaining information for identifying a cell and information for identifying a frequency channel of the second base station may be operable to perform at least one of: i) obtain the information for identifying a cell and the information for identifying a frequency channel of the second base station by decoding a Radio Resource Control, RRC, container communicated, via the gateway apparatus, between the first base station and the second base station; ii) obtain the information for identifying a cell and the information for identifying a frequency channel of the second base station from one or more information element included in the received message (e.g. a ‘UE History Information’ information element and/or a ‘Last Visited E-UTRAN Cell Information’ information element); iii) obtain the information for identifying a cell and the information for identifying a frequency channel of the second base station from a message (e.g. a ‘S1 Setup Request’ message) for setting up the second base station for S1 communication via the gateway apparatus; and iv) obtain the information for identifying a cell and the information for identifying a frequency channel of the second base station from an operations and maintenance (OAM) entity.

The gateway apparatus may comprise at least one of a small cell gateway and a home base station gateway operating in accordance with the Long Term Evolution (LTE) set of standards.

Various other modifications will be apparent to those skilled in the art and will not be described in further detail here.

This application is based upon and claims the benefit of priority from United Kingdom patent application No. 1411149.6, filed on Jun. 23, 2014, the disclosure of which is incorporated herein in its entirety by reference.

1. A base station for a communication system, the communication system comprising at least one mobile communication device, a plurality of base stations, a gateway apparatus operable to facilitate communication of messages between the plurality of base stations, and a mobility management entity via which the gateway apparatus is connectable to a core network, the base station comprising:
at least one processor configured to:
generate a message for initiating a handover of the mobile communication device from the base station to another base station, the message comprising a security context associated with the mobile communication device, the security context including: a key for securing communications with the mobile communication device; and a current value of an associated counter for deriving a further key for securing subsequent communications with the mobile communication device; and
send the generated message to the gateway apparatus, the message including the security context.

2. The base station according to claim 1, wherein the key for securing communications with the mobile communication device comprises a key specific to the other base station.

3. A base station for a communication system, the communication system comprising at least one mobile communication device, a plurality of base stations, a gateway apparatus operable to facilitate communication of messages between the plurality of base stations, and a mobility management entity via which the gateway apparatus is connectable to a core network, the base station comprising:
at least one processor configured to:
generate a message for initiating a handover of the mobile communication device from the base station to another base station, the message comprising information for identifying a cell and information for identifying a frequency channel of the other base station, wherein the information is included in one or more non-radio resource control, non-RRC encoded information elements configured to convey cell information between the base station and other nodes of the communication system; and
send the generated message to the gateway apparatus, the message including the one or more non-RRC encoded information elements.

4. A base station for a communication system, the communication system comprising at least one mobile communication device, a plurality of base stations, a gateway apparatus operable to facilitate communication of messages between the plurality of base stations, and a mobility management entity via which the gateway apparatus is connectable to a core network, the base station comprising:
a least one processor configured to:
receive a message from the gateway apparatus, the message requesting the base station to carry out a handover of the mobile communication device from another base station, the message comprising a security context associated with the mobile communication device, the security context including: a key for securing communications with the mobile communication device; and a current value of an associated counter for deriving a further key for securing subsequent communications with the mobile communication device;
perform the requested handover of the mobile communication device; and
secure communications with the mobile communication device using the received key.

5. The base station according to claim 4, wherein the received key for securing communications with the mobile communication device comprises a key specific to the other base station; and wherein the at least one processor of the base station is further configured to derive a further key specific to the base station using the received key and the associated counter.

6. The base station according to any of claims 1 to 5, comprising at least one of a macro base station, a pico base station, a femto base station, and a home base station operating in accordance with the Long Term Evolution (LTE) set of standards.

7. A gateway apparatus comprising:
at least one processor configured to:
receive a message, from a first base station, for initiating a handover of a mobile communication device from the first base station to a second base station, the received message comprising:
(a) data to be forwarded to the second base station, the data relating to the handover of the mobile communication device from the first base station to the second base station;
(b) a security context associated with the mobile communication device, the security, context including: a key for securing communications with the mobile communication device; and a current value of an associated counter for deriving a further key for securing subsequent communications with the mobile communication device:
generate a message requesting the second base station to carry out a handover of the mobile communication device from the first base station, the generated message comprising information for deriving a further key for securing communications with the mobile communication device, wherein the information for deriving a further key is included in a security context portion forming part of the generated message; and
send the generated message to the second base station.

8. The gateway apparatus according to claim 7, wherein the received key for securing communications with the mobile communication device is specific to the first base station, and wherein the information for deriving a further key comprises the received key and the associated counter.

9. The gateway apparatus according to claim 7, wherein the key for securing communications with the mobile communication device is specific to the second base station, and wherein the information for deriving a further key comprises the received key.

10. A gateway apparatus comprising:
at least one processor configured to:
obtain, from a core network node, a security context associated with a mobile communication device, the security context including: a key for securing communications with the mobile communication device; and a current value of an associated counter for deriving a further key for securing subsequent communications with the mobile communication device;
receive a message, from a first base station, for initiating a handover of the mobile communication device from the first base station to a second base station, the received message comprising data to be forwarded to the second base station, the data relating to the handover of the mobile communication device from the first base station to the second base station;
generate an information for deriving a further key for securing communications with the mobile communication device;
generate a message requesting the second base station to carry out a handover of the mobile communication device from the first base station, the generated message comprising the information for deriving a further key for securing communications with the mobile communication device, wherein the information is included in a security context portion forming part of the generated message; and
send the generated message to the second base station.

11. The gateway apparatus according to claim 10, wherein the at least one processor is further configured to obtain information for identifying a cell and information for identifying a frequency channel of the second base station.

12. The gateway apparatus according to claim 11, wherein the gateway apparatus is further configured to perform at least one of:
i) obtain the information for identifying a cell and the information for identifying a frequency, channel of the second base station by decoding a Radio Resource Control (RRC) container communicated, via the gateway apparatus, between the first base station and the second base station;
ii) obtain the information for identifying a cell and the information for identifying a frequency channel of the second base station from one or more information element included in the received message;
iii) obtain the information for identifying a cell and the information for identifying a frequency channel of the second base station from a message for setting up the second base station for communication via the gateway apparatus; and
iv) obtain the information for identifying a cell and the information for identifying a frequency channel of the second base station from an operations and maintenance (OAM) entity.

13. The gateway apparatus according to any of claims 7 to 12, comprising at least one of a small cell gateway and a home base station gateway operating in accordance with the Long Term Evolution (LTE) set of standards.

14. A communication system comprising the base station according to any of claims 1 to 6;
and the gateway apparatus according to any of claims 7 to 13.

15. A method performed by a base station in a communication system, the communication system comprising at least one mobile communication device, a plurality of base stations, a gateway apparatus operable to facilitate communication of messages between the plurality of base stations, and a mobility management entity via which the gateway apparatus is connectable to a core network, the method comprising:
generating a message initiating a handover of the mobile communication device from the base station to another base station, the message comprising a security context associated with the mobile communication device, the security context including: a key for securing communications with the mobile communication device; and a current value of an associated counter for deriving a further key for securing subsequent communications with the mobile communication device; and
sending the generated message to the gateway apparatus, the message including the security context.

16. A method performed by a base station in a communication system, the communication system comprising at least one mobile communication device, a plurality of base stations, a gateway apparatus operable to facilitate communication of messages between the plurality of base stations, and a mobility management entity via which the gateway apparatus is connectable to a core network, the method comprising:
generating a message for initiating a handover of the mobile communication device from
the base station to another base station the message comprising information for identifying a cell and information for identifying a frequency channel of the other base station, wherein the information is included in one or more non-radio resource control, non-RRC, encoded information elements configured to convey cell information between the base station and other nodes of the communication system; and
sending the generated message to the gateway apparatus, the message including the one or more information elements.

17. A method performed by a base station in a communication system, the communication system comprising at least one mobile communication device, a plurality of base stations, a gateway apparatus operable to facilitate communication of messages between the plurality of base stations, and a mobility management entity via which the gateway apparatus is connectable to a core network, the method comprising:
receiving a message from the gateway apparatus, the message requesting the base station to carry out a handover of the mobile communication device from another base station, the message comprising a security context associated with the mobile communication device, the security context including: a key for securing communications with the mobile communication device; and a current value of an associated counter for deriving a further key for securing subsequent communications with the mobile communication device;
performing the requested handover of the mobile communication device; and
securing communications with the mobile communication device using the received key.

18. A method performed by a gateway apparatus, the method comprising:
receiving a message, from a first base station, for initiating a handover of a mobile communication device from the first base station to a second base station, the received message comprising:
(a) data to be forwarded to the second base station, the data relating to the handover of the mobile communication device from the first base station to the second base station;
(b) a security context associated with the mobile communication device, the security context including: a key for securing communications with the mobile communication device; and a current value of an associated counter for deriving a further key for securing subsequent communications with the mobile communication device;
generating a message requesting the second base station to carry out a handover of the mobile communication device from the first base station, the generated message comprising information for deriving a further key for securing communications with the mobile communication device, wherein the information for deriving a further key is included in a. security context portion forming part of the generated message; and
sending the generated message to the second base station.

19. A method. performed by a gateway apparatus, the method comprising:
obtaining, from a core network node, a security context associated with a mobile communication device, the security context including: a key for securing communications with the mobile communication device; and a current value of an associated counter for deriving a further key for securing subsequent communications with the mobile communication device;
receiving a message from a first base station, the message initiating a handover of the mobile communication device from the first base station to a second base station, the received message comprising data to be forwarded to the second base station, the data relating to the handover of the mobile communication device from the first base station to the second base station:
generating information for deriving a further key for securing communications with the mobile communication device;
generating a message requesting the second base station to carry out a handover of the mobile communication device from the first base station, the generated message comprising the information for deriving a further key for securing communications with the mobile communication device, wherein the information is included in a security context portion forming part of the generated message; and
sending the generated message to the second base station.

20. A non-transitory computer program product comprising instructions for causing a computer programmable device to perform a method according to any of claims 15 to 19.
